(19) United States
(12) Patent Application Publication
(10) Pub. No.: US 2024/0203720 A1
(43) Pub. Date: Jun. 20, 2024

(54) MULTIPLEXED ELECTROSPRAY IONIZATION SOURCES USING ORTHOGONAL INJECTION INTO AN ELECTRODYNAMIC ION FUNNEL

(71) Applicant: Purdue Research Foundation, West Lafayette, IN (US)

(72) Inventors: Julia Laskin, West Lafayette, IN (US); Pei Su, West Lafayette, IN (US); Carlos Larriba, Indianapolis, IN (US); Xi Chen, Indianapolis, IN (US)

(21) Appl. No.: 18/287,357

(22) PCT Filed: Apr. 15, 2022
(86) PCT No.: PCT/US2022/024973

§ 371 Date: Oct. 18, 2023

Related U.S. Application Data
(60) Provisional application No. 63/177,170, filed on Apr. 20, 2021.

(51) Int. Cl. H01J 49/06; H01J 49/04; H01J 49/10; H01J 49/16

(52) U.S. Cl. CPC H01J 49/066; H01J 49/0468; H01J 49/107; H01J 49/165

(57) ABSTRACT

The invention generally relates to systems and methods for systems and methods for multiplexed electrospray ionization. In certain embodiments, electrospray ionization sources orthogonally inject ions into an ion funnel with at least two of the sources injecting on the same side of the ion funnel.

### RELATED APPLICATION

The present application claims the benefit of and priority to U.S. provisional patent application Ser. No. 63/177,170, filed Apr. 20, 2021, the content of which is incorporated by reference in its entirety.

### GOVERNMENT SUPPORT

This invention was made with government support under 1904879 awarded by National Science Foundation. The government has certain rights in the invention.

### FIELD OF THE INVENTION

The invention generally relates to systems and methods for multiplexed electrospray ionization.

### BACKGROUND

Electrospray ionization (ESI) is one of the most widely employed atmospheric pressure ionization techniques in mass spectrometry (MS). In a typical ESI process, a high voltage is used to generate charged microdroplets from a liquid containing the analyte; the charged droplets undergo desolvation during which analyte ions are exposed and transferred into vacuum of a mass spectrometer. ESI is widely employed both for analytical and preparative MS applications due to its simplicity and ease of operation, its soft ionization nature preventing ion fragmentation in the source, its exceptional compatibility with liquid-phase separation techniques, and its broad access to a wide range of molecules.

ESI is a promising ionization technique for producing high-intensity molecular ion beams for MS applications. Bright ion sources are beneficial to analytical applications because they enhance the sensitivity and improve the duty cycle of mass spectrometers. Moreover, preparative MS using brighter ion sources improves the efficiency of surface and materials preparation using ions. Early research on ion current improvement was focused on the efficient collection and transfer of ESI-generated ions into vacuum. Specially-shaped heated capillary inlets have been employed to substantially increase the ion transmission at the atmosphere-vacuum interface of a mass spectrometer. Optimization of the inner diameter and length of the heated inlet results in an improved ion transmission. In addition, a subambient pressure ionization source interfaced with an electrodynamic ion funnel has been developed to eliminate the loss of ion transmission in the atmosphere-vacuum interface. However, further ion current improvement is inhibited by the maximum amount of charge carried by ESI droplets known as the Rayleigh limit. To overcome this limitation, several studies used multiplexing of the individual ESI emitters to increase the signal. In particular, there has been a substantial effort dedicated to assembling ESI emitter arrays for both the analytical MS applications and ESI-based propulsion.

Recent advancements include a space-charge-guided ambient ion beam merging using 3D-printed devices and arrayed emitters arranged in a circular pattern, which have substantially improved the overall signal and sensitivity of the instrument. Despite significant advances in this field, multiplexing of ion beams still results in substantial ion losses, which limit its analytical utility.

### SUMMARY

The invention provides systems and methods for multiplexing of ESI sources. Aspects of the invention include two or more heated inlets orthogonally injecting ions generated by separate ESI sources into an ion funnel. At least two heated inlets are located on the same side of the ion funnel while one or more additional inlets may be located on the opposite side. Such a layout can provide more than 3-fold increase in total current compared to current generated from a single inlet and analytical performance can increase along with the increased total ion current. In certain embodiments, the total ion current produced may be approximately proportional to the number of inlets provided in the multiplexed apparatus.

A drawback of earlier multiplexed arrangements (see FIG. 1) is the requirement that ion sources be located at opposite sides to avoid crosstalk or other deleterious effects between adjacent ion inlets. Accordingly, multiplexed sources were limited to two. Configurations of the present invention recognize that by positioning the sources to maintain certain spacing and angle requirements, multiple ion sources and inlets can be included on a single side, thereby allowing for multiplexing of 3, 4, 5, 6, or more sources.

In certain aspects, the invention provides an apparatus for multiplexed electrospray ionization. The apparatus may include a vacuum chamber, a plurality of ESI sources coupled to the vacuum chamber by a plurality of heated inlets. The plurality of heated inlets can introduce ions to the vacuum chamber orthogonal to a direction of an ion beam within the vacuum chamber. The two or more of the plurality of heated inlets can be located on the same side of the vacuum chamber and positioned such that each heated inlet introduces ions into the vacuum chamber at a point at least about 1 mm away from where another heated inlet introduces ions into the vacuum chamber.

In various embodiments, the heated inlets may be positioned such that each heated inlet introduces ions into the vacuum chamber at a point at least about 2 mm away from where each other heated inlet introduces ions into the vacuum chamber, at least about 3 mm away from where each other heated inlet introduces ions into the vacuum chamber, at least about 4 mm away from where each other heated inlet introduces ions into the vacuum chamber, at least about 5 mm away from where each other heated inlet introduces ions into the vacuum chamber, or at least about 6 mm away from where each other heated inlet introduces ions into the vacuum chamber. In certain embodiments, the heated inlets may be positioned at least 10 mm or at least 20 mm away from where each other heated inlet introduces ions into the vacuum chamber.

In certain embodiments, the vacuum chamber comprises an ion funnel. The ion funnel may include a plurality of ring electrodes having a linearly decreasing inner diameter along the direction of the ion beam within the vacuum chamber. The plurality of ring electrodes can have inner diameters that linearly decrease from about 50.8 mm to about 2.5 mm.

The vacuum chamber may comprise a repeller section upstream of the ion funnel along the direction of the ion beam within the vacuum chamber. The plurality of inlets can introduce ions to the vacuum chamber at the repeller section. The outlet of the vacuum chamber can be coupled to an inlet of a second vacuum chamber having a lower pressure than the vacuum chamber. The second vacuum chamber can comprise a second ion funnel.

An outlet of the second vacuum chamber may be coupled to an inlet of a bent flatapole ion guide. An outlet of the bent flatapole ion guide can direct the ion beam through a quadrupole mass filter to be focused by an einzel lens and directed onto a surface. The surface can be a current collector plate. The two or more of the plurality of heated inlets located on the same side of the vacuum chamber may be contained in a cartridge removably coupled to a first port in the side of the vacuum chamber. In certain embodiments, three or more of the plurality of heated inlets may be located on the same side of the vacuum chamber.

In some embodiments, an apparatus of the invention may further comprise one or more additional electrospray ionization sources coupled to an opposite side of the vacuum chamber from the two or more of the plurality of heated inlets located on the same side of the vacuum chamber. In certain embodiments, additional ESI sources may be coupled along the axis of the ion funnel. The one or more additional electrospray ionization sources can be coupled to the opposite side of the vacuum chamber upstream or downstream of the vacuum chamber from the two or more of the plurality of heated inlets located on the same side of the vacuum chamber along the direction of the ion beam within the vacuum chamber. That arrangement can be termed a staggered layout. In certain embodiments, a single heated inlet may be fed by two or more ESI emitters. Multiple heated inlets can then drive the ions into the vacuum chamber.

Aspects of the invention include a method for focusing ions comprising the steps of: introducing ions into a vacuum chamber from a plurality of electrospray ionization sources independently coupled to the vacuum chamber by a plurality of heated inlets, wherein the plurality of heated inlets introduce the ions into the vacuum chamber orthogonal to a direction of an ion beam within the vacuum chamber, and wherein two or more of the plurality of heated inlets are located on a same side of the vacuum chamber; and focusing the ions in an ion beam at an outlet of the vacuum chamber. The two or more inlets located on the same side of the vacuum chamber can be positioned such that each heated inlet introduces ions into the vacuum chamber at a point at least about 1 mm away from where another heated inlet introduces ions into the vacuum chamber. Methods may further comprise directing the focused ion beam from the outlet of the vacuum chamber into an inlet of a second vacuum chamber having a lower pressure than the vacuum chamber. In certain embodiments, methods may include further focusing the ion beam in the second ion funnel and directing the further focused ion beam from an outlet of the second vacuum chamber into an inlet of a bent flatapole ion guide. Additional steps may comprise cooling the ion beam in the bent flatapole ion guide, filtering the cooled ion beam in a quadrupole mass filter, and focusing the filtered ion beam with an einzel lens onto a surface.

### BRIEF DESCRIPTION OF THE DRAWINGS

FIG. 1 shows a prior art dual-polarity instrument for ion soft landing.

FIG. 2 panel A shows a drawing of an exemplary two-inlet cartridge used for multiplexing experiments.

FIG. 2 panel B shows a sectioned drawing of an exemplary ion funnel with two two-inlet cartridges implemented.

FIG. 2 panel C shows the front and top view of a complete drawing of an exemplary funnel implemented with four heated inlets.

FIG. 3 panel A shows IonCCD profiles of Ru(bpy)₃²⁺

FIG. 3 pane B shows the corresponding peak heights and SNRs for FIG. 3a extracted from Lorentzian curve fitting.

FIG. 3 panel C shows shows IonCCD profiles of substance P.

FIG. 3 panel D shows the corresponding peak heights and SNRs for FIG. 3c extracted from Lorentzian curve fitting.

FIG. 4 panel A shows mass-selected ion current of a few model cluster ions in ESI×1 and ESI×4 mode.

FIG. 4 panel B shows mass-selected ion current of ubiquitin ions in ESI×1 and ESI×4 mode.

FIG. 4 panel C shows mass-selected ion current of B12Cl122- in ESI×2 mode using a different combination of inlets.

FIG. 4 panel D shows the stability of mass-selected ion current of B12Cl122- over an hour of time period.

FIG. 5 panel A shows ion current of Ru(bpy)₃²⁺ as a function of RF amplitude.

FIG. 5 panel B shows ion current of Ru(bpy)₃²⁺ as a function DC gradient.

FIG. 5 panel C shows ion current of Ru(bpy)₃²⁺ as a function pressure in the ion funnel.

FIG. 6 Top panel shows gas flow dynamics in the three-dimensional space of an exemplary HPF.

FIG. 6 Bottom panel shows a SIMION simulation of ions (m/z=600) entering the exemplary HPF under the effect from both gas flow dynamics shown in (a) and RF and DC electric field.

FIG. 7 shows a cross-section of an exemplary vacuum chamber having four heated orthogonal inlets directing ions into the vacuum chamber.

FIG. 8 shows an exemplary cartridge containing three heated inlets therein.

### DETAILED DESCRIPTION

An electrodynamic ion funnel is commonly used on both commercial and custom-designed mass spectrometers. An ion funnel is typically composed of a stack of ring electrodes applied with RF and DC voltages to efficiently focus and transmit ion beam in a wide pressure range (typically 0.1-30 Torr, up to atmospheric pressure). ESI-generated ions are typically injected along the axial or orthogonal directions. In particular, an orthogonally injected ion beam is delivered into the ion funnel through a heated inlet protruding into a cutout section on one side of the ion funnel. It has been shown that orthogonal injection has a better ion transmission compared to axial injection. In addition, orthogonal injection decouples ion transfer from the gas flow dynamics, which efficiently eliminates the neutral contaminants and droplets entrained by the gas flow from the ion source.

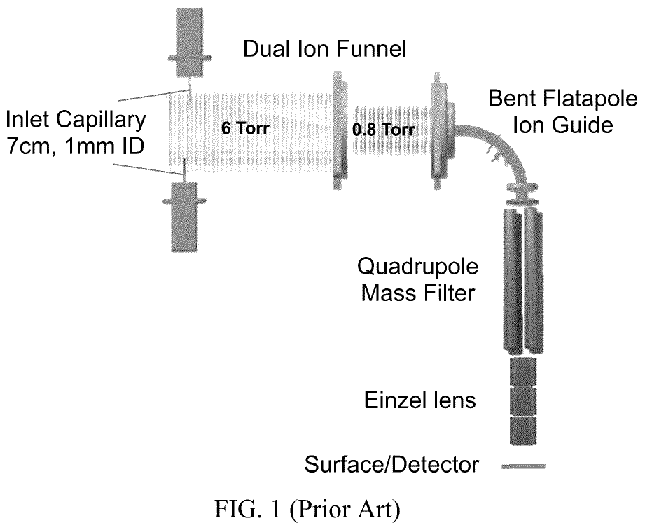

Herein, a design of multiplexed ESI sources is reported using multiple orthogonal injections into an ion funnel. A total of four orthogonal inlets are used for injection of ion beams into an ion funnel. The two pairs of heated inlets are implemented on the opposite sides of the ion funnel with each of them equipped with an independently operated ESI emitter. A more than 3-fold increase in total ion current was observed with four inlets as compared to the current generated from one inlet. The analytical performance obtained using multiplexing improves in proportion with the total ion current. For a few model systems of different charge state and over a broad mass range, the total ion current produced using orthogonally multiplexed ESI source is almost proportional to the number of inlets. A major obstacle in incorporating two or more inlets on the same side of the vacuum chamber is avoiding crosstalk or other negative effects caused by interactions between ions and neutral beams injected from the adjacent inlets. While the aforementioned 2× multiplex arrangements in the prior art such as depicted in FIG. 1 could avoid these issues, they were limited to a single inlet on each side rendering multiplexing at 3× or higher unfeasible. The current invention has determined the proper spacing and angles required to avoid deleterious interactions of adjacent ion and neutral streams allowing for two, three, or more inlets to be included on each side.

### Experimental Section

The multiplexed ESI capability is implemented on a custom-designed dual polarity ion soft landing instrument described in detail elsewhere. Briefly, the instrument is composed of a high-transmission ESI interface (Spectroglyph, LLC) containing a tandem electrodynamic ion funnel system and a bent flatapole ion guide similar to the system shown in FIG. 1. A high-pressure ion funnel (HPF) is housed in a vacuum chamber differentially pumped to 7 Torr by a dry screw vacuum pump (VARODRY VD200, 118 cubic feet per minute (cfm), Leybold GmbH, Cologne, Germany). A low-pressure ion funnel (LPF) is mounted in the second vacuum stage differentially pumped to 0.8 Torr by a multistage Roots vacuum pump (ECODRY 65 plus, 32 cubic feet per minute (cfm), Leybold GmbH, Cologne, Germany). The third chamber which houses the bent flatapole ion guide is pumped down to 10-20 mTorr using a 90 L/s turbomolecular pump (TURBOVAC 90 I, Leybold GmbH, Cologne, Germany). The fourth vacuum stage, in which ion current detection and ion beam characterization are performed, is differentially pumped to 3−6×10⁻⁵ Torr by a 350 L/s turbomolecular pump (TURBOVAC 350 I, Leybold GmbH, Cologne, Germany). The two turbomolecular pumps are backed by ECODRY 65 plus used for the second vacuum chamber.

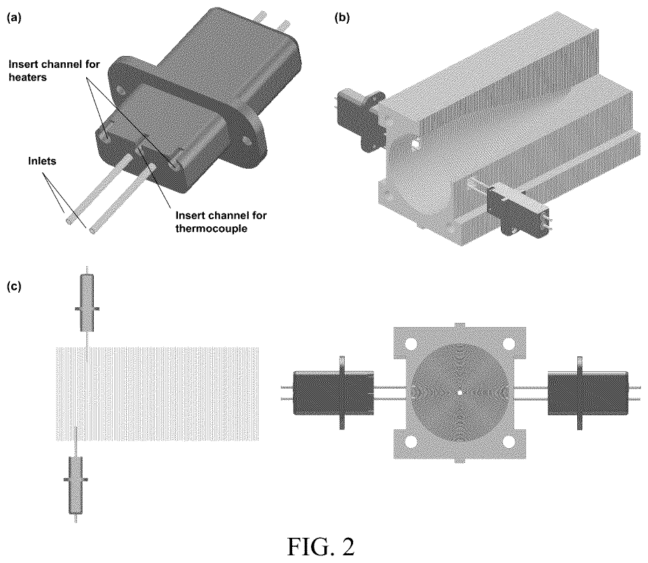

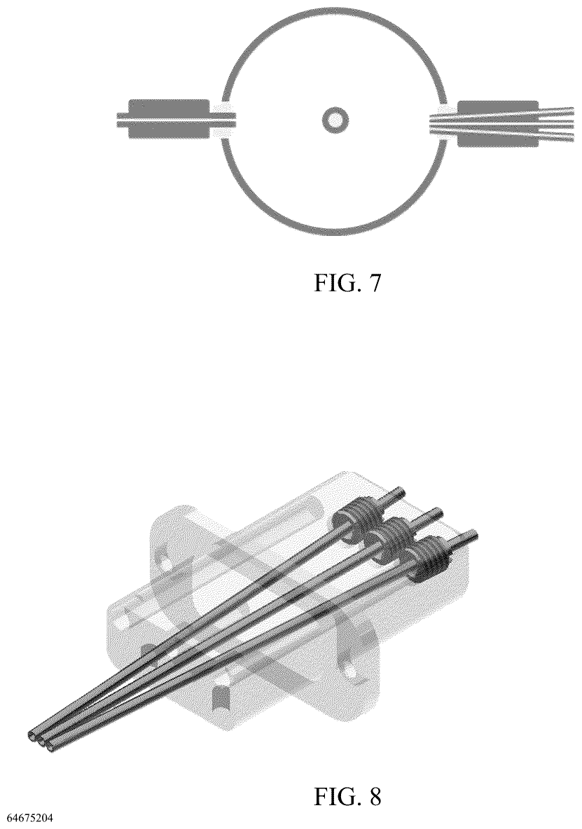

An earlier high-transmission ESI interface described in Su, P.; Hu, H.; Warneke, J.; Belov, M. E.; Anderson, G. A.; Laskin, J. Design and Performance of a Dual-Polarity Instrument for Ion Soft Landing. Anal. Chem. 2019, 91, 5904-5912 is depicted in FIG. 1 and is equipped with two orthogonal injection ESI sources. Ions are introduced into vacuum through stainless steel heated inlet tubes from the opposite sides of the HPF. Each inlet tube is mounted using a stainless-steel cartridge. The temperature of each heated inlet is maintained by a cartridge heater and a thermocouple. To implement multiplexed ESI sources, the heated cartridges were modified to accommodate two inlets on each side of the HPF. A detailed drawing of the cartridge is shown in FIG. 2a. In particular, two heated inlets ( 1/16″ OD, 0.04″ ID, 7 cm length, VICI Valco Instruments, Houston, TX) are inserted through the center of the cartridge and are spaced by 6 mm. Two 24V 60 W cartridge heaters (⅛″ dia., 1¼″ long, Gordo Sales, Layton, UT) are connected in series and inserted into the side channels of cartridge to provide enough heating power for efficient desolvation of the ESI droplets. A thermocouple wire is inserted into the channel in between the heaters. The temperature of the cartridges is typically maintained at 180° C. to improve the desolvation of the ESI droplets. In certain embodiments, a cartridge may contain 2, 3, 4, 5, or more individual inlets to allow for a single vacuum chamber to be configured to multiplex various numbers of sources simply by swapping cartridges or by only using a few inlets within a cartridge. FIG. 8 shows an exemplary cartridge having three inlets. By using two such cartridges arranged orthogonal to the ion beam in the vacuum chamber and positioned opposite each other, anywhere up to six ion sources can be multiplexed. FIG. 7 shows an exemplary configuration in cross-section using a single inlet cartridge opposite a three-inlet cartridge to allow for multiplexing of up to four ion sources.

In order to avoid crosstalk, adjacent inlets should be positioned such that their outlet points where ions are introduced into the vacuum chamber (e.g., ion funnel) are spaced at least 1 mm apart. In various embodiments, the adjacent inlets may be spaced at least about 2, at least about 3, at least about 4, at least about 5, at least about 6 mm apart, at least 10 mm apart, at least 15 mm apart, at least 20 mm apart, at least 25 mm apart, or at least 30 mm apart.

An additional advantage of cartridges is the ability to tightly control the spacing and angles of each adjacent jet in order to avoid deleterious interactions therebetween. Accordingly, setup time when switching between cartridges and multiplex arrangements can be greatly reduced by maintaining a preset inlet spacing in each cartridge.

The HPF is specially designed for orthogonal injection inlets (FIG. 2b). In particular, it is composed of a repeller section and a funnel-shaped section. The repeller section is assembled using a stainless-steel plate with two slot windows and a stack of 28 ring electrodes with identical inner diameters of 50.8 mm (2 in). Two cutouts (dimension) on the opposite side of the repeller section of the HPF are implemented for introducing the ion beam into the ion funnel. The two cutouts are implemented at staggered locations along the axis of the HPF to improve the gas dynamics of the ion funnel. In particular, one cutout is positioned between the 9^{th} and the 16^{th} ring electrodes, while the other one is positioned between the 14^{th} and the 21^{st} ring electrodes. The heated inlets protrude into the cutouts of the HPF by ˜1 mm, which is the optimized position for ion transmission. FIG. 2c shows a cross-sectional diagram of the funnel on the radial plane when the four orthogonal inlets are inserted into the funnel. The funnel-shaped section of the HPF is composed of 85 ring electrodes with IDs decreasing linearly from 50.8 mm to 2.5 mm (0.1 in). The last ring electrode acts as a conductance limit between the first and the second vacuum chambers.

Direct infusion ESI is used to generate ions in all the experiments discussed in this work. In particular, a solution of a selected analyte ion is filled into a gastight syringe (Hamilton Robotics, Reno, NV) and introduced into the ESI source through a MicroTight union (P-720, IDEX Health & Science, Oak Harbor, WA) and a fused silica capillary (100 μm ID, 360 μm OD, l'length, Polymicro Technologies, Phoenix, AZ) using a syringe pump (Cole-Palmer, Vernon Hills, IL) at a typical flow rate of 60 μL h⁻¹. Other suitable ion sources include atmospheric pressure chemical ionization (APCI), atmospheric Pressure Photoionization (APPI), desorption electrospray ionization (DESI), nano-DESI, matrix-assisted laser desorption/ionization (MALDI), laser ablation electrospray ionization (LAESI), and any other ambient ionization source. Charged microdroplets are produced by applying a +3 kV voltage to the stainless-steel syringe needle. The microdroplets are transferred into the ion funnel through a heated inlet where desolvation takes place to generate ions. In the multiplexed mode where more than one direct infusion capillary is used to generate ions, each capillary is aligned with a specific heated inlet. The capillaries used to introduce ions from the same side of the HPF are held by PEEK sleeves (F-388, IDEX Health & Science, Oak Harbor, WA) mounted on a 3D-printed bracket. The bracket is mounted on a 3-axis Dovetail translation stage (DT12XYZ, Thorlabs Inc., Newton, NJ), which allows for the optimization of the position of the ESI capillaries with respect to the inlets.

In a typical experiment where mass-selected ion beam is measured after a quadrupole mass filter, an orthogonally-injected ion beam is focused by the gas and electric field in the HPF and transferred into the low-pressure funnel and the bent flatapole ion guide where collisional cooling takes place. Ions are subsequently transferred into high vacuum and mass-selected using the quadrupole mass filter, focused by an einzel lens, and directed onto a current collector plate connected to a picoammeter (RBD Instruments, Bend, OR) for ion current measurement. The picoammeter is typically operated at a sampling rate of 300 ms, and the current reported for a specific ion is averaged over a time period of >30 s.

The analytical performance of the multiplexed source is evaluated using a mass-dispersive device, rotating wall mass analyzer (RWMA) described in detail elsewhere. Specifically, ion beam transferred through the bent flatapole ion guide is directed into high vacuum and sent to the RWMA through an einzel lens. Ions of different m z are spatially dispersed into concentric rings of different radii by RWMA. Ion beam after the RWMA is characterized using a position-sensitive IonCCD (OI Analytical, Pelham, AL) detector. The ring-shaped ion beam is characterized by a pair of peaks symmetrically located around the center of the one-dimensional IonCCD profile. Data acquisition using the IonCCD detector is performed by first acquiring a baseline profile during which the ion beam is switched off; in the following step, ion beam is switched on, and the ion beam profile is obtained by averaging 50 consecutive profiles each acquired at an integration time of 10 ms. The intensity of a signal in the IonCCD profile is obtained using Lorentzian curve fitting from which the peak height is extracted. The noise level is analyzed using a section of the IonCCD profile in the range of x=(−5 mm, 5 mm) where no ion signal is present. The raw IonCCD profile is first fitted with a 3^{rd} order polynomial using a Savitzky-Golay filter embedded in OriginLab (Northampton, MA) with 50 points of window; next, the noise is extracted by calculating the standard deviation of the raw profile from the fitted profile. Signal-to-noise ratio (SNR) is obtained by taking the ratio of the peak height and the noise.

All chemicals purchased from Sigma-Aldrich (St. Louis, MO) and used to demonstrate the performance of multiplexing are listed here: Tris(2,2′-bipyridyl)dichlororuthenium(II) hexahydrate (Ru(bpy)₃·6H₂O, CAS: 50525-27-4), sodium phosphotungstate tribasic hydrate (Na₃[PW₁₂O₄₀]·xH₂O, CAS: 12026-98-1), substance P acetate salt hydrate (CAS: 137348-11-9, anhydrous), ubiquitin from bovine erythrocytes (>98% purity, CAS: 79856-22-4). (TBA)₂B₁₂Cl₁₂ salt. Na[V₆O₇(OCH₃)₁₂] and [Co₆S₈(PEt₃)₆]Cl was synthesized according to reported procedures. The solution used for ESI-MS of Substance P ions was prepared in methanol/H₂O=90%/10% as the solvent at a concentration of 100 μM. Ubiquitin ions were generated from a solution prepared at a concentration of ˜0.05 mg mL⁻¹ in a solvent of methanol/H₂O/CH₃COOH=49.5%/49.5%/1%. Other analytes were dissolved in methanol at a concentration of 150 μM unless specified otherwise.

Gas flow simulations were performed using SolidWorks 2019 (Waltham, MA). Ion trajectory simulations were performed using SIMION 8.0.4 (Scientific Instrument Services, Ringoes, NJ). In the SIMION simulations, the gas velocity field was first imported into the electrode geometry to investigate the motion of ions under the effect of both gas flow dynamics and the electric field.

### Results and Discussion

In the current configuration of multiplexing, four inlets were implemented for orthogonal ion beam injection into the high-pressure funnel (HPF). This is based on the consideration of the cutout size on the existing HPF and the maximum pumping power available. We use the ESI×n (n=1-4) notation to represent the number of inlets in use to introduce ion beams generated from the individual ESI emitters.

First the analytical performance of the multiplexing was characterized when different numbers of inlets were used to generate the same ion. Instead of using a quadrupole mass filter to generate a mass spectrum, a mass-dispersive device, rotating wall mass analyzer (RWMA) was employed which separates signal and noise onto spatially-distinct locations in the same spectrum. The design and performance of RWMA as a mass analyzer has been reported. Briefly, RWMA is comprised of a cylinder segmented into eight arc shaped electrodes. When sinusoidal waveforms were applied with sequential 45 degree phase shift to the electrodes, a rotating electric field is constructed in the center of the device. When a continuous ion beam is transferred along the central axis of RMWA, ions of different m z are dispersed onto ring shaped areas of distinct radii on a surface. In a typical experimental setup, a position-sensitive IonCCD detector was used to characterize the ion beam. A ring-shaped ion beam is detected as a pair of signals symmetrically located around the center of the one-dimensional IonCCD profile.

The multiplexing performance was evaluated using several model systems.

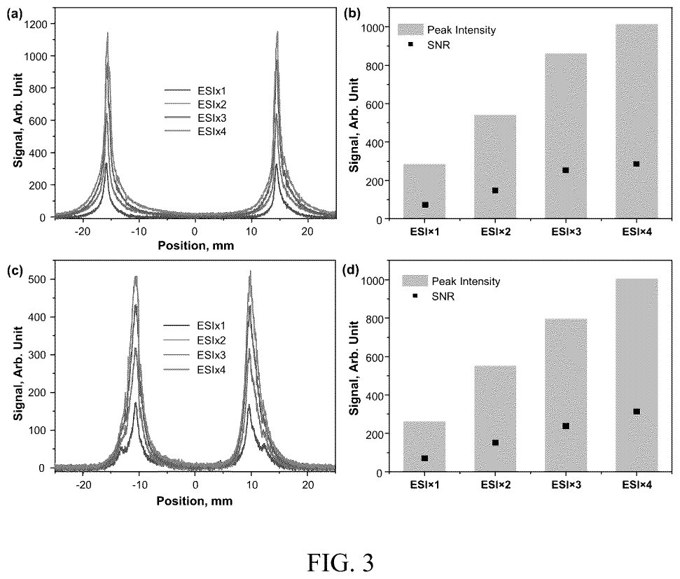

FIG. 3a shows the IonCCD profiles obtained for a cationic organometallic complex, Ru(bpy)₃²⁺ (m/z=275) in ESI×n (n=1-4) modes (when different number of inlets was in use). The pair of peaks in each profile was assigned to Ru(bpy)₃²⁺ as the dominant ionic species generated in the ESI source. The peak height shown in FIG. 3b increases almost proportionally with the number of inlets in use, with a slightly lower increase from ESI×3 to ESI×4 mode. With similar noise level in all ESI×n (n=1-4) modes, multiplexing of four ESI sources results in a 3.8-fold increase in signal-to-noise ratio (SNR) in ESI×4 mode.

The IonCCD profiles obtained for a model peptide, substance P, in ESI×n (n=1-4) modes are shown in FIG. 3c. Two peaks are observed at ˜−10 mm and ˜10 mm corresponding to doubly charged substance P ([M+2H]²⁺) as a dominant species in the mass spectrum. A pair of peaks at ˜−12 mm and ˜12 mm was clearly observed in the IonCCD profile of ESI×1 mode, which was assigned to triply charged substance P ([M+3H]³⁺). In the IonCCD profiles of ESI×n (n=2-4) modes, the [M+3H]³⁺ signal merged with [M+2H]²⁺ and was observed as a pair of shoulder peaks. To analyze the signal produced by [M+2H]²⁺, the IonCCD profiles were fitted with a combination of two Lorentzian distributions with x coordinates locked throughout all the profiles. The peak height of [M+2H]²⁺ and the corresponding SNRs were extracted from the curve fitting results and displayed in FIG. 3d. Again, a proportional increase in both signal and SNR was observed when more inlets were used. In contrast to Ru(bpy)₃²⁺ (FIG. 3b), the proportionally increasing trend persists from ESI×3 to ESI×4 mode as well. This may be attributed to the higher overall ion current for Ru(bpy)₃²⁺ than substance P ions, which leads to the space-charge-induced transmission loss.

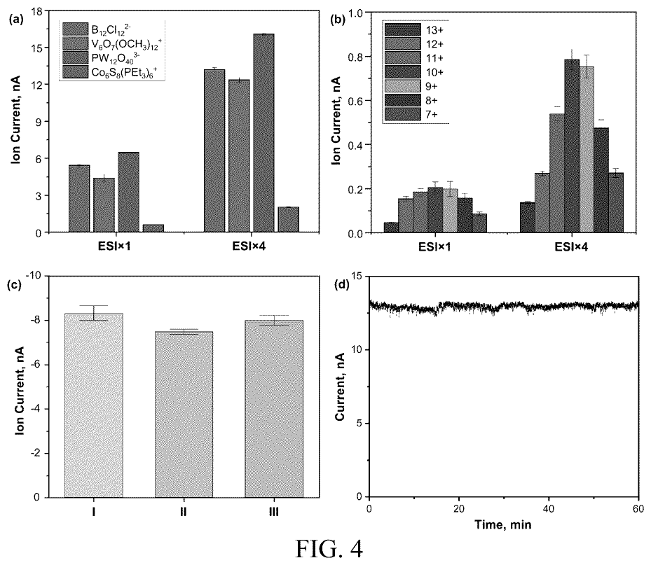

To evaluate the applicability of the multiplexing approach to a broad range of ions, a few model systems of interest to applications from bioanalytical to materials sciences were selected. In these experiments, a quadrupole mass filter was used to mass-select one particular ionic species at a time and compare the ion current when different number of inlets were in use. FIG. 4a shows the mass-selected current of a dodecaborate anion, B₁₂Cl₁₂²⁻ (m/z=277), an anionic methoxo-oxovanadium cluster, V₆O₇(OCH₃)₁₂⁻ (m/z=790), a phosphotungstate anion, PW₁₂O₄₀³⁻ (m/z=958), and a cationic metal chalcogenide superatomic cluster, Co₆S₈(PEt₃)₆⁺ (m/z=1317), in ESI×1 and ESI×4 mode. Using multiplexing in ESI×4 mode, a 2.8-fold increase was obtained on average in the total ion current compared to the current generated using a single ESI emitter.

FIG. 4b shows the ion current of different charge states of a model protein, ubiquitin (M=8.6 K), generated from an acidic environment. An LTQ mass spectrum of 5 μM ubiquitin in 49.5:49.5:1 methanol/H₂O/CH₃COOH (v/v/v) shows a charge state distribution centered at 10+. The same solution was used to test the multiplexing of ubiquitin ion beam in ESI×4 mode. In ESI×4 mode, a 3.1-fold increase on average in ion current was observed for ubiquitin ions of charge states from 7+ to 13+. This confirms the applicability of multiplexing to a broad range of molecular ions.

While the device shown in FIG. 1 allowed for multiplexing of the same ions by introducing two orthogonal injections from opposite sides of the ion funnel, systems and methods of the current invention allow for injection of independent ion beams from three, four, or more orthogonal inlets by introducing two of them on each side of the funnel. The total ion current obtained in the ESI×4 mode was higher than reported in previous work. It is hypothesized that the performance of multiplexing is independent of which of the inlets are used. To test the hypothesis, the ESI×2 mode was operated in by introducing the two ion beams from the same and the opposite side of the ion funnel. FIG. 4c shows the mass-selected ion current of B₁₂Cl₁₂²⁻ obtained in the ESI×2 mode with different position of ion beam injection. Similar ion current was observed independent of which of the two inlets were used for ion beam injection. This proves that orthogonally-injected ion beam introduced from different positions of the ion funnel can be efficiently merged to create a brighter ion beam.

The multiplexing approach also provides a direct path to generate stable high-brightness ion current over an extended period of time, which is particularly advantageous for preparative mass spectrometry applications. FIG. 4d show the mass-selected ion current of B₁₂Cl₁₂²⁻ in ESI×4 mode, which was observed to be stable for at least an hour (FIG. 4d). This corresponds to a deposition rate of ˜20 μg of mass-selected ions per day, which substantially improves the efficiency of ion deposition experiments.

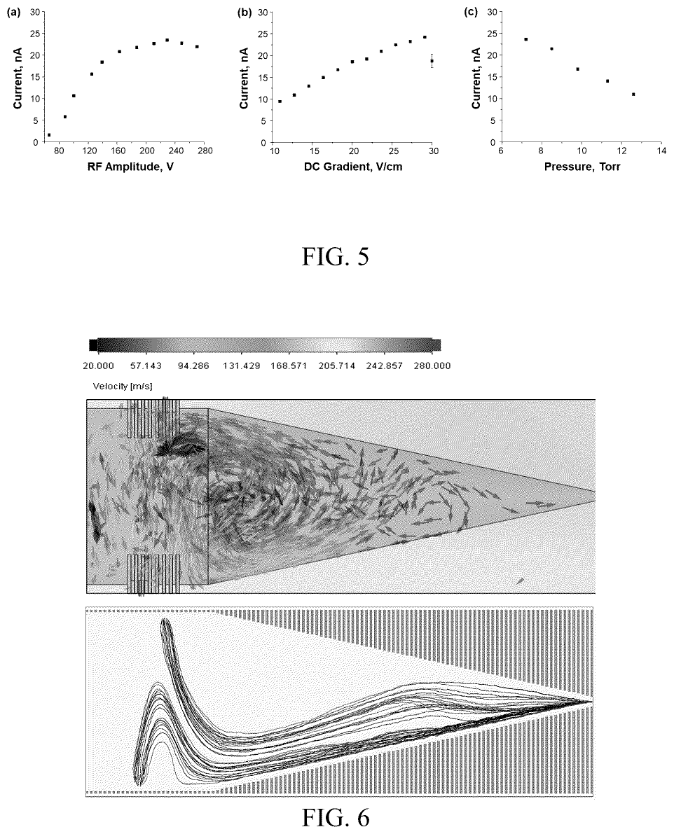

The ion transmission efficiency of ion funnels strongly depends on the operating pressure and tuning parameters for ion topics. In particular, the radiofrequency (RF) electric field facilitates the radial confinement of the ion cloud; meanwhile, the DC field promotes the ions to move to the downstream ion optics along the axis of the funnel. These parameters have been extensively characterized in the first implementation of orthogonal injection into an ion funnel, where a pumping port is positioned on the opposite side. In this study, a particular focus is in how RF field, DC field, and pressure in the ion funnel affects the transmission of a high-intensity ion beam generated by multiplexing in ESI×4 mode. In these experiments, Ru(bpy)₃²⁺ was selected as the model system; ion current was measured on the rods of the bent flatapole ion guide, which corresponds to the transmitted ion current through the tandem ion funnel system. It is noted that ESI of Ru(bpy)₃Cl₂ in methanol produces Ru(bpy)₃²⁺ ions as the only dominant ionic species in positive ion mode. Although the ion current collection was performed before the mass-selection stage, these measurements provide direct insights into the transmission efficiency of ion funnel independent of the performance of the downstream ion optics when a high-intensity ion beam is transmitted. FIG. 5a shows the ion current transmitted at different RF amplitudes at a resonance frequency of 740 kHz. The transmission efficiency increased with increased RF level, and a plateau was reached at ˜230 Vₚ₋ₚ. Further increase in rf level resulted in a decrease in transmission, which may be attributed to the higher low-mass-cut-off at relatively high rf levels. Compared to the typical rf level used when only two orthogonal inlets were coupled to the ion funnel operated at a similar pressure, the optimal rf level found for ESI×4 mode is substantially higher. This may be attributed to the space charge effect from a stronger ion cloud in ESI×4 mode, which requires a deeper RF potential well to radially confine the ion beam. In addition, the gas dynamics in ESI×4 mode is expected to be distinctly different from ESI×2 mode when four stream of gas flows are introduced from the opposite side.

FIG. 5b shows the transmitted ion current at different DC gradients. The HPF is composed of a repeller section and a funnel section as described in the experimental section. The DC gradient in the repeller section did not play an important role in improving the ion transmission. In contrast, the ion current increases with a higher axial DC gradient in the funnel region. The highest ion current was obtained at a DC of voltage 320 V. Further increasing the DC gradient caused a failure in the electronic power supply, which results in a substantially dropped unstable ion current (FIG. 5b, DC voltage at 330 V).

The effect of pressure on ion transmission was also studied and the results are shown in FIG. 5c. The operating pressures in the ion funnel were adjusted by choking the valve on the VARODRY VD 200 mechanical pump. The highest ion transmission was observed at the lowest pressure with the highest obtainable pumping power (7.25 Torr). Increasing the pressure in the ion funnel results in proportionally decreased ion current. It is anticipated that the ion transmission may be further improved if more powerful pumps are employed.

To obtain additional insights about the ion transmission in ESI×4 mode, a combined gas flow dynamics and ion trajectory simulation was carried out. Specifically, the vacuum chamber that houses the HPF was built in the model. The model was subsequently imported into SIMION where ion trajectories were simulated. FIG. 6a shows the gas flow dynamics in the three-dimensional space. The repeller region where gas was introduced into the ion funnel shows the highest gas flow velocity, which manifests the supersonic gas expansion in vacuum. The streams of gas flow from the opposite side of the ion funnel interact with each other and form a vortex gas flow with a relatively lower velocity. The gas flow streams merge together in the funnel-shaped region and move towards the exit of the HPF, which facilitates the transmission of the ion beam. This is validated by the ion trajectory simulation in FIG. 5b and experimentally observed additive ion transmission from the four inlets in ESI×4 mode.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein.

1. An apparatus for multiplexed electrospray ionization, the apparatus comprising:
a vacuum chamber;
a plurality of ionization sources independently coupled to the vacuum chamber by a plurality of heated inlets,
wherein the plurality of heated inlets introduce ions to the vacuum chamber orthogonal to a direction of an ion beam within the vacuum chamber, and
wherein two or more of the plurality of heated inlets are located on a same side of the vacuum chamber and are positioned such that each heated inlet introduces ions into the vacuum chamber at a point at least about 1 mm away from where each other heated inlet introduces ions into the vacuum chamber; and
an outlet.

2. The apparatus of claim 1 wherein the vacuum chamber comprises an ion funnel.

3. The apparatus of claim 2 wherein the ion funnel comprises a plurality of ring electrodes having a linearly decreasing inner diameter along the direction of the ion beam within the vacuum chamber.

4. The apparatus of claim 3 wherein the plurality of ring electrodes have inner diameters that linearly decrease from about 50.8 mm to about 2.5 mm.

5. The apparatus of claim 2 wherein the vacuum chamber comprises a repeller section upstream of the ion funnel along the direction of the ion beam within the vacuum chamber.

6. The apparatus of claim 5, wherein the plurality of inlets introduce ions to the vacuum chamber at the repeller section.

7. The apparatus of claim 2 wherein the outlet of the vacuum chamber is coupled to an inlet of a second vacuum chamber having a lower pressure than the vacuum chamber.

8. The apparatus of claim 7 wherein the second vacuum chamber comprises a second ion funnel.

9. The apparatus of claim 8 wherein an outlet of the second vacuum chamber is coupled to an inlet of a bent flatapole ion guide.

10. The apparatus of claim 9 wherein an outlet of the bent flatapole ion guide directs the ion beam through a quadrupole mass filter, focused by an einzel lens, and directed onto a surface.

11. The apparatus of claim 1 wherein the ionization source is selected from the group consisting of electrospray ionization (ESI), atmospheric pressure chemical ionization (APCI), atmospheric Pressure Photoionization (APPI), desorption electrospray ionization (DESI), nano-DESI, matrix-assisted laser desorption/ionization (MALDI), and laser ablation electrospray ionization (LAESI).

12. The apparatus of claim 1 wherein the two or more of the plurality of heated inlets located on the same side of the vacuum chamber are contained in a cartridge removably coupled to a first port in the side of the vacuum chamber.

13. The apparatus of claim 1 wherein three or more of the plurality of heated inlets are located on the same side of the vacuum chamber.

14. The apparatus of claim 1 further comprising one or more additional ionization sources coupled to an opposite side of the vacuum chamber from the two or more of the plurality of heated inlets located on the same side of the vacuum chamber.

15. The apparatus of claim 14 wherein the one or more additional ionization sources are coupled to the opposite side of the vacuum chamber upstream or downstream of the vacuum chamber from the two or more of the plurality of heated inlets located on the same side of the vacuum chamber along the direction of the ion beam within the vacuum chamber.

16-30. (canceled)
